(19) United States
(12) Patent Application Publication
(10) Pub. No.: US 2011/0240746 A1
(43) Pub. Date: Oct. 6, 2011

(54) RADIO FREQUENCY IDENTIFICATION TAG USING A RELAXOR FERROELECTRIC SUBSTRATE HAVING A MICRO POLAR REGION AND METHOD FOR MANUFACTURING THE SAME

(76) Inventor: Man Sun Yun, Chungcheongbuk-do (KR)

(21) Appl. No.: 13/122,333

(22) PCT Filed: Oct. 2, 2008
(86) PCT No.: PCT/KR08/05822

§ 371 Date: Jun. 14, 2011

(51) Int. Cl. G06K 19/077; C04B 35/64

(52) U.S. Cl. 235/492; 264/611

(57) ABSTRACT

The present invention improves characteristics of a tag antenna for RFID with a ceramic material exhibiting characteristics of a relaxor ferroelectric substance. More specifically, the present invention relates to an RFID tag that is formed of a relaxor ferroelectric substance having a dielectric constant of 3,000 or more and comprising a non-lead based oxide to have an expanded usage, and to exhibit improved orientation by forming the non-lead based relaxor ferroelectric substance in a planar disc or other shapes by a general dry-forming method or by forming the non-lead based relaxor ferroelectric substance in various shapes by powder injection molding.

### TECHNICAL FIELD

The present invention relates to tag antennas for radio frequency identification (hereinafter, referred to as “RFID”) and, more particularly, to an RFID tag capable of normally operating when attached to a metal.

### BACKGROUND ART

RFID systems generally include RFID tags, various forms of antennas, readers according to performances, a local-host for supporting the readers, various cablings, and a network.

In the RFID system, the RFID tag stores information relating to overall processes of manufacturing, distribution, storage and consumption, and includes antennas incorporated therein.

The information in the tag is read by the reader and is used in an information system integrated through an artificial satellite or a mobile communication network.

A principle of operating RFID can be briefly described as follows: when a tag approaches a reader, the tag receives a radio wave transmitted from the reader. Then, the tag is activated by the energy of the received radio wave and transmits information stored in the tag to the reader by the radio wave carrying the information.

The RFID can be categorized into a passive type and an active type according to a method of obtaining an energy source of the radio wave. The passive type obtains transmission energy from the radio wave sent from the reader, and the active type obtains the transmission energy from a separate battery.

FIG. 1 is a conceptual view illustrating an operating principle of a passive RFID system.

Referring to FIG. 1, a radio wave 13 transmitted from an antenna 12 of a reader 11 is received by a tag antenna 141, so that an electric power is supplied to activate the tag 14. The power supplied from the radio wave 13 to the tag 14 operates an electronic chip 142, which is coupled to the tag antenna 141, via a rectifier circuit. The electronic chip 142 stores information of an associated article. Then, the information stored in the electronic chip 142 is carried by a reflected wave 15 to the antenna 12 of the reader 11. As a result, the information stored in the electronic chip 142 is transmitted to the reader.

Here, an intensive radio frequency is generated from the antenna by an inductive coupling technique in a frequency band of 30 MHz or less to generate a magnetic field, so that electric current is generated to operate the tag when the magnetic field passes through an antenna coil of the tag. In this case, the magnetic field tends to be absorbed by a metal.

Like a laser technique, an inverse-scattering technique employs power generated when the radio wave sent from the antenna is received by the tag, and can be employed in a frequency band of 100 MHz or more. In this technique, the magnetic field tends to be reflected by a metal and absorbed by water.

FIG. 2 is a conceptual view of a conventional passive RFID tag.

Referring to FIG. 2, an electronic chip 21 stores information of an article that has a tag 20 attached thereto.

The antenna 22 is activated by a signal sent from the antenna of the reader and serves to transmit the information stored in the electronic chip 21 to the reader.

The electronic chip 21 and the antenna 22 are attached to a substrate 23, which in turn is attached to the article.

Specifically, the electronic chip 21 is operated by an RF signal received by the antenna 22 on the tag 20. The RF signal received by the antenna 22 causes generation of alternating current in a wiring of the tag antenna 22 due to electromagnetic inductance, and the alternating current is rectified by an RF diode to supply a power to the electronic chip 21.

The alternating current induced to the tag antenna by the received RF energy varies identical to variation of the RF energy, so that an electromagnetic wave generated by the alternating current is transmitted from the tag antenna 22 to the reader antenna.

In other words, since the tag antenna 22 does not need a separate power source, such a tag can be referred to as a passive tag, which is differentiated from an active tag that requires a separate battery.

The size of the RF tag is determined according to a resonance frequency received by the tag antenna. When the RF tag is located above a material capable of conducting the RF, that is, a metal, the RF tag must be separated by a distance of at least ¼ of the RF wavelength from the metal to ensure that a reflected wavelength has an inverse phase relative to a wavelength induced to the metal, to minimize reflection of the RF.

For example, when using a frequency of 900 MHz, an RF wave has a wavelength of 33.3 cm in air according to Equation 1.

$$λ = \frac{3 \times {10}^{10} ( \frac{cm}{sec} )}{9 \times {10}^{8} ( \frac{1}{sec} )} = 33.3 cm \qquad [ Equation 1 ]$$

Accordingly, the RF tag must be separated from a metal plate by a distance of 8.2 cm, which is ¼ of the wavelength, to minimize signal loss at the reader antenna through minimization of RF reflection from the metal plate.

Such a restriction causes a restriction in utility of the RF tag.

A reason for restricting attachment of the tag to the metal is caused by an eddy current formed in the metal.

FIG. 3 is a conceptual view depicting a principle of inducing an eddy current on a metal plate.

Referring to FIG. 3, a magnetic field 31 generated from a reader antenna enters a tag in a direction of the negative y-axis to induce an eddy current 33 on a metal plate 32 to which the tag is attached, in which the eddy current 33 is generated in the counterclockwise direction.

According to Fleming's right hand rule, the eddy current 33 is generated to counterbalance the magnetic field 31 which is induced through an antenna coil of the tag, so that a magnetic field 34 is generated in a direction of the positive y-axis. That is, the magnetic field is generated in the direction for counterbalancing the magnetic field which is induced from the reader antenna to the tag antenna, thereby causing the RFID to be inoperable on the metal plate.

When generated by the eddy current on the surface of the metal plate, the magnetic field is formed in the vertical direction with respect to the metal plate, which is a direction of reducing the magnetic field induced from the reader antenna, according to Lenz's rule, thereby finally cancelling out the magnetic field from the reader antenna. As a result, the magnetic field incoming from the reader antenna to the tag is canceled, and the tag cannot generate an induced current, thereby causing the RFID tag to be inoperable on the metal plate.

One conventional technique for preventing this phenomenon will be described hereinafter.

FIG. 4 is a cross-sectional view of a conventional RFID tag proposed to solve inoperability of the RFID system caused by the eddy current.

Referring to FIG. 4, a ferrite magnetic substance 43 is located between the surface of a metal plate 41 and a tag antenna coil 42. Here, when a magnetic field 44 is incident into the tag antenna coil 42 from the reader antenna in the negative y-axis direction, an electric current is induced in the clockwise-direction on the tag antenna coil perpendicular to the magnetic field according to Fleming's right hand rule.

The current is indicated by the following marks. \textcircled{X} indicates that the current is directed downward from the ground, and ⊙ indicates that the current is directed upward from the ground.

Materials suitable for RF applications are prepared using Fe₂O₃ oxide with a low content of Br as main raw materials. These materials have a higher resistance of 1˜10⁶ Ω/m, as compared to a metal having a resistance of 10⁻⁵˜10⁻⁴ Ωm. Thus, when induced into the ferrite material, the eddy current is lost as heat by the high resistance of the ferrite material, so that generation of the eddy current is suppressed. As a result, generation of the inverse magnetic field caused by the eddy current is also suppressed, so that inoperability of the reader antenna relating to the inverse magnetic field can be prevented.

In another attempt, BaTiO₃ and SrTiO₃ are prepared and processed to have a dielectric constant of 10 or more, followed by mixing with a binder and a silk screen or tape casting process to form a thick film, which in turn is hardened at 300° C. and used as a substrate for the tag antenna.

A principle of this attempt is in minimization of a distance of λ/4 with such a dielectric material, wherein the distance of λ/4 is suggested to counterbalance the reflection of RF in air. Theoretically, the wavelength of RF in air is expressed by the expression:

$$λ ∝ \frac{1}{\sqrt{ɛ}}$$

In this expression, λ is a wavelength in the dielectric material ands is ∈ dielectric constant thereof. Accordingly, although the distance of λ/4 for minimizing RF reflection in air is 8.2 cm for an RF of 900 MHz, the use of a dielectric material having a dielectric constant of 100 can reduce the distance of λ/4 to one tenth thereof, that is, to 0.82 cm.

In other words, when the tag antenna is disposed on the dielectric material formed to have a thickness of 0.82 cm, it is possible to reduce the distance for minimizing the reflection of the eddy current on the surface of the metal plate.

In this attempt, however, the reader antenna can be affected by the eddy current, which can be induced on the surface of the metal plate by the RF transmitted through the binder or pores of the binder that is an organic material mixed with dielectric powders. Further, this attempt requires accurate control of dimensions, thereby causing restrictions in application.

### DISCLOSURE

### Technical Problem

The present invention is conceived to solve the problems of the conventional techniques as described above, and an aspect of the present invention is to provide an RFID tag that uses a relaxor ferroelectric substance having a micro polar region formed therein to allow the RFID tag to be directly attached to an article, such as a metal, which tends to reflect an RF signal, based on characteristics of the micro polar region, thereby enabling the RF signal to be transmitted between a reader antenna and the tag without any loss.

It should be noted that the present invention is not limited to this aspect, and that the above and other aspects of the present invention will be more clearly understood by a person having ordinary knowledge in the art from the following detailed description taken in conjunction with the accompanying drawings.

### Technical Solution

In accordance with an aspect of the present invention, an RFID tag includes: an electronic chip configured to store information; a tag antenna configured to transmit and receive an RF signal to and from a reader antenna; and a substrate having the electronic chip and the tag antenna thereon, wherein the substrate comprises a relaxor ferroelectric substance having a micro polar region formed therein.

The tag antenna may be bonded to one or both sides of the relaxor ferroelectric substrate having the micro polar region by a conductive epoxy.

In accordance with another aspect of the present invention, there is provided a method for manufacturing an RFID tag substrate having a composition of (Ba_{0.82}Ca_{0.18})(Ti_{0.96-y}Zr_{y}Sn_{0.04})O₃ and exhibiting characteristics of a relaxor ferroelectric substance, the method including: preparing a mixture of BaTiO₃, CaCO₃, TiO₂, ZrO₂, and SnO₂ powders by wet-mixing for 15˜17 hours; preparing a first powder by drying and calcining the mixture at 1,000° C. for 1˜3 hours; preparing a second powder by wet-pulverizing the first powder for 15˜17 hours, followed by drying the pulverized first powder; preparing a compact by pressing and then hydro-forming the second powder; and sintering the compact at 1,300˜1,350° C. for 1˜3 hours at a temperature elevation rate of 3˜7° C./min.

The relaxor ferroelectric substance may have a chemical formula of ABO₃. In this formula, A is one selected from Pb⁺², Ca⁺², Ba⁺², La⁺³, Na⁺¹, K⁺¹, Ce⁺³, Bi⁺³, and a mixture thereof, and B is one selected from Mg⁺², Nb⁺⁵, Ti⁺⁴, Zr⁺⁴, Ta⁺⁵, W⁺⁶, Mn⁺², Ni⁺², Y⁺³, Te⁺⁶, and a mixture thereof.

The above and other aspects, features and advantages of the invention, and a method for accomplishing them will become apparent from the following embodiments described in conjunction with accompanying drawings. However, it should be noted that the present invention is not limited to the embodiments described herein and can be implemented in various forms. The embodiments are given for the purpose of complete disclosure of the present invention and help a person having ordinary knowledge in the art to fully understand the scope and spirit of the present invention, as defined only by the accompanying claims.

### Advantageous Effects

As apparent from the above description, according to the present invention, an RFID tag is directly attached to an article tending to reflect an RF signal, such as a metal, by micro polar region characteristics of a relaxor ferroelectric substance, so that the RF signal can be transmitted between a reader antenna and the tag without any loss.

### DESCRIPTION OF DRAWINGS

FIG. 1 is a conceptual view depicting an operation principle of a passive RFID system;

FIG. 2 is a conceptual view of a conventional passive RFID tag;

FIG. 3 is a conceptual view depicting a principle of inducing an eddy current on a metal plate;

FIG. 4 is a cross-sectional view of a conventional RFID tag proposed to solve inoperability of a conventional RFID tag caused by the eddy current;

FIG. 5 is conceptual views depicting rearrangement of ionic dipoles according to variation of an eddy current;

FIG. 6 is a graph depicting frequency dependency of a dielectric constant near a maximum dielectric constant of a relaxor ferroelectric substance;

FIG. 7 is a conceptual view illustrating dipoles existing between a micro polar region and a matrix;

FIG. 8 is a conceptual view illustrating a principle of restraining an eddy current direction using micro dipoles;

FIG. 9 is a graph depicting variation in dielectric constant depending on temperature in Comparative Example;

FIG. 10 is a graph depicting variation in dielectric constant depending on temperature when an added amount of ZrO₂ is increased from 9 mol % to 14 mol % in a composition of (Ba_{0.82}Ca_{0.18})(Ti_{0.96-y}Zr_{y}Sn_{0.04})O₃; and

FIG. 11 is a perspective view of a parabolic ferroelectric substrate.

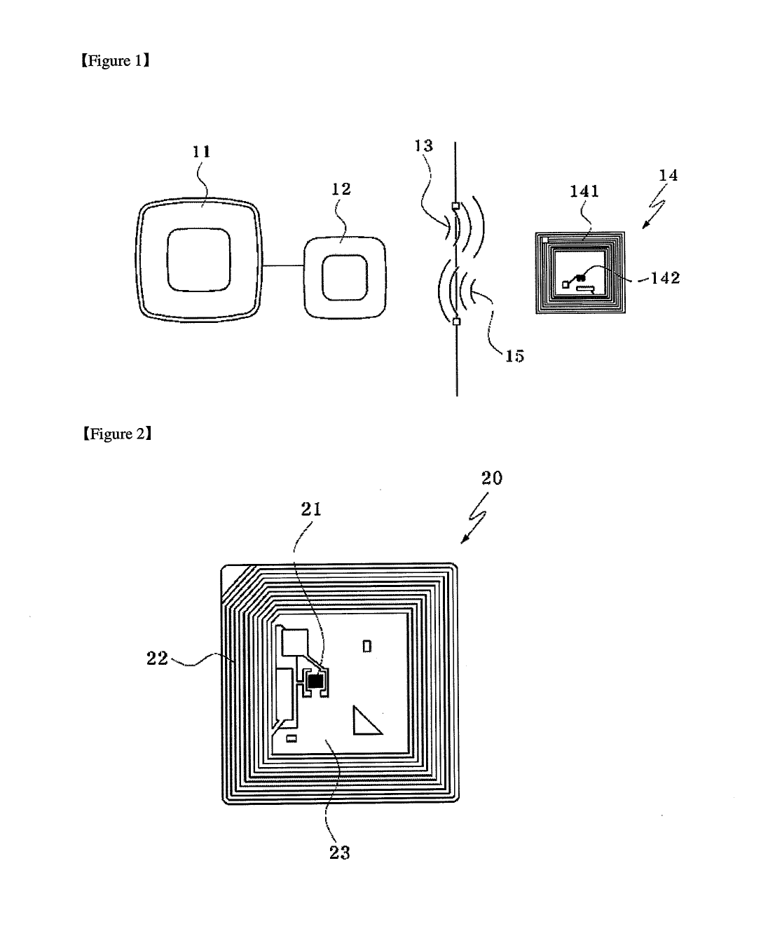

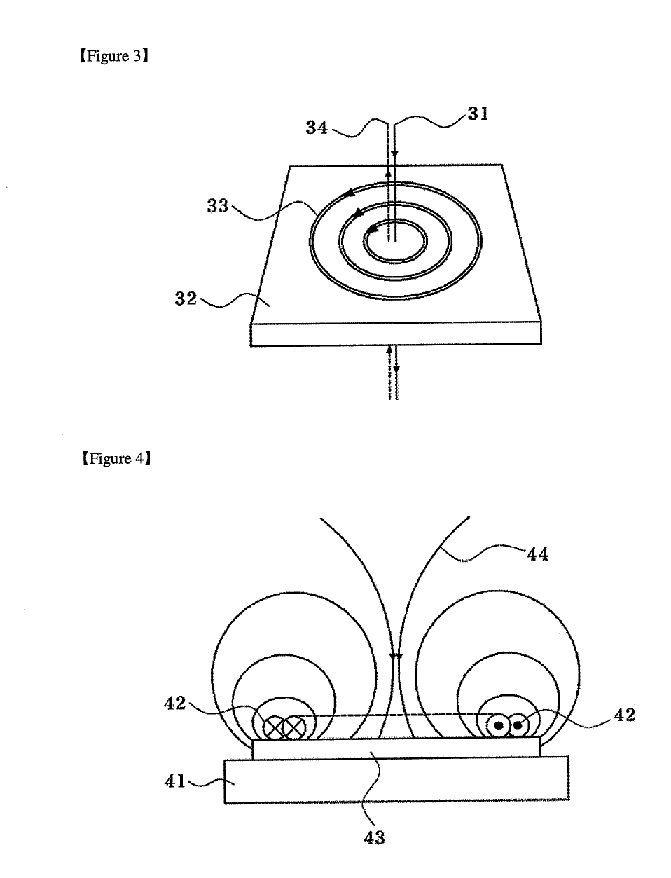

### BEST MODE

The present invention improves characteristics of a tag antenna for RFID with a ceramic material exhibiting characteristics of a relaxor ferroelectric substance. More specifically, the present invention relates to an RFID tag for expanding the usage of the tag antenna by using a relaxor ferroelectric substance having a dielectric constant of 3,000 or more and comprising a non-lead based oxide, and improving directivity of the tag antenna by forming the non-lead based relaxor ferroelectric substance in a planar disc or other shapes by a general dry-forming method or by forming the non-lead based relaxor ferroelectric substance in various shapes by powder injection molding.

The relaxor ferroelectric substance has a chemical formula of ABO₃. In this formula, A may comprise one selected from Pb⁺², Ca⁺², Ba⁺², La⁺³, Na⁺¹, K⁺¹, Ce⁺³, Bi⁺³, and a mixture thereof; and B may comprise one selected from Mg⁺², Nb⁺⁵, Ti⁺⁴, Zr⁺⁴, W⁺⁶, Mn⁺², Ni⁺², Co⁺², Y⁺³, Te⁺⁶, and a mixture thereof.

If A is a mixture of two ions, a mixing ratio of the two ions may be 1/2:1/2, and if B is a mixture of two ions, a mixing ratio of the two ions may be 1/2:1/2, or 1/3:2/3.

For example, if A and B each comprise a single ion, a chemical formula may be represented in the form of Pb⁺²Ti⁺⁴O₃. If A comprises two ions and B comprises a single ion, a chemical formula may be represented in the form of (Pb⁺²_{1/2}Ca⁺²_{1/2})Ti⁺⁴O₃.

Further, if A comprises a single ion and B comprises two ions, a chemical formula may be represented in the form of Ba⁺²(Ni⁺²_{1/3}Ti⁺⁵_{2/3})O₃. If A and B each comprise two ions, a chemical formula may be represented in the form of (Pb⁺²_{1/2}Ca⁺²_{1/2}) (Y⁺³_{1/2}Ti⁺⁵_{1/2})O₃.

According to the invention, an antenna of the RF tag is mounted on a relaxor ferroelectric substrate having a high dielectric constant by using a conductive epoxy, so that an eddy current may be generated on the conductive epoxy used to bond the relaxor ferroelectric substrate, due to an induced current generated by the antenna of the tag. In such a case, the generated eddy current causes a micro polar region in the relaxor ferroelectric substrate to be arranged in an electric field direction of the eddy current.

At this time, since the micro polar region cannot be rearranged corresponding to a high frequency of 900 MHz and maintains an initial direction of the electric filed, the micro polar region restrains the induced current within the conductive epoxy to prevent variation of the eddy current. Accordingly, Lenz's rule is not applied to the micro polar region, so that an inverse magnetic field which removes an induced magnetic field of a reader antenna may not be generated.

The micro polar region may be present at a temperature in the range of −40˜60° C. Since the RFID tag is mainly used in this temperature range, the micro polar region should be present in this temperature range to correctly operate the RFID.

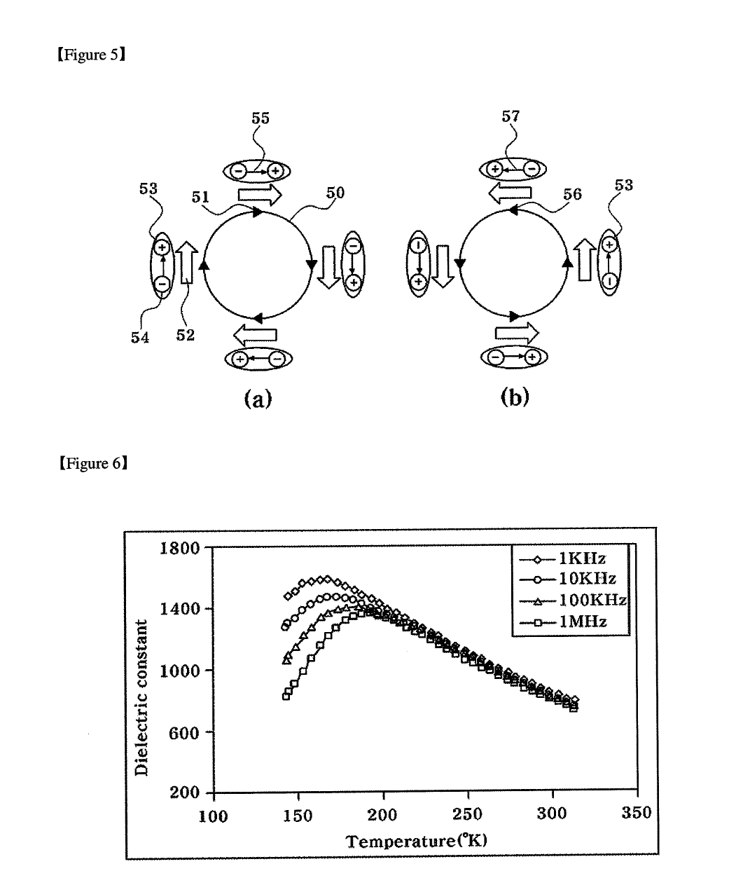

FIG. 5 is conceptual views depicting rearrangement of ion dipoles depending to variation of the eddy current.

Generally, an ionic bonding material undergoes rearrangement of ions at the same rate as a rate of change in direction of an external electric field to several dozen GHz by the external electric field.

As shown in (a) of FIG. 5, an arrow 51 indicates a direction of an electric field generated on the surface of a dielectric substance by an eddy current 50. Here, as indicated by an arrow 52, a normal direction at each point on an electric field circle is the direction of the electric field.

At this time, a cation 53 and an anion 54 in ionic bonding within the dielectric substance in the same direction as the direction of the electric field are rearranged to form an ionic dipole 55 as shown in (a) of FIG. 5.

Herein, a polarization direction is always directed from a negative charge to a positive charge.

When the intensity of the magnetic field generated from the reader antenna is reduced by LC resonance, the direction of the eddy current is changed and an ionic polarization direction 57 is also changed at the same rate as the rate of changing the direction of the eddy current to prevent reduction in intensity of the magnetic field generated from the tag antenna, as indicated by arrow 56 in (b) of FIG. 5. Accordingly, it is impossible to prevent generation of the inverse magnetic field due to the eddy current on the conductive silver epoxy coated on the dielectric substance.

However, it is possible to prevent variation in direction of the eddy current by using a polarization of the micro polar region, which is not susceptible to a frequency variation.

FIG. 6 is a graph depicting frequency dependency of a dielectric constant near a maximum dielectric constant of a relaxor ferroelectric substance.

In FIG. 6, a voltage of 1 Vrms is applied to the relaxor ferroelectric substance.

As shown in FIG. 6, as a phase transition temperature (maximum dielectric constant temperature) is widely expanded (increase in peak broadness) and a frequency is increased, the maximum dielectric constant is lowered.

Smolensky et al. described this phenomenon as an alleviation phenomenon that occurs when the polarization between a regular micro region of a regular structure having a negative charge and a matrix of an irregular structure having a positive charge within the relaxor ferroelectric substance fails to follow the frequency variation.

That is, although the dipole can be rearranged according to the frequency variation at 100 Hz, an increase of the frequency prevents rearrangement of the dipole and causes the dipole to be stopped at an original position, thereby reducing the dielectric constant.

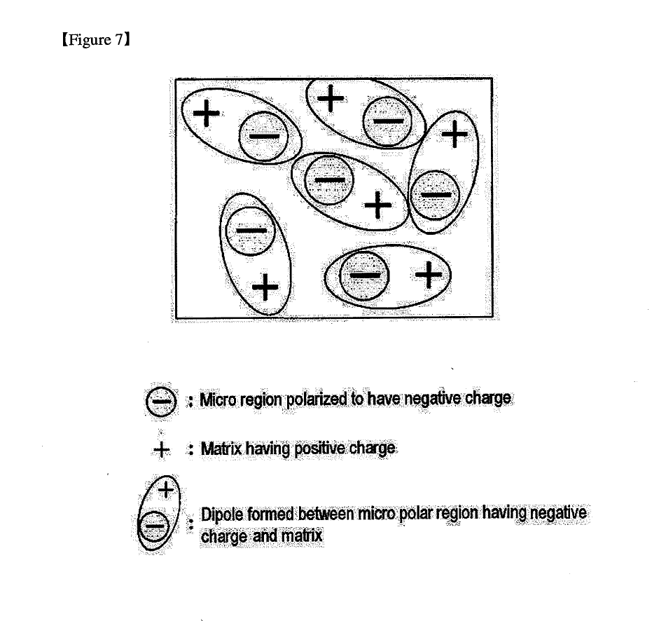

FIG. 7 is a conceptual view illustrating dipoles existing between a micro polar region and a matrix.

Herein, a polarization direction is always directed from a negative charge to a positive charge.

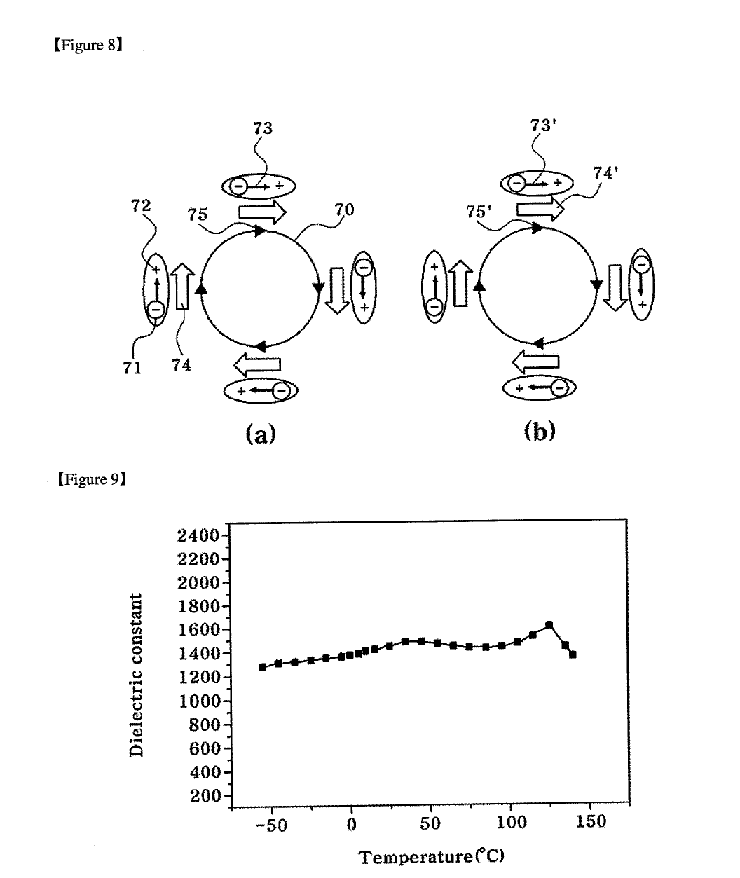

Such a dipole has been found not to have a size on the order of angstroms, as in the ionic dipole, but to have a relatively large nanometer-scale size, thereby causing stress around the dipole during variation of the polarization direction. As a result, although the polarization direction cannot be rapidly changed and it is more difficult to vary the polarization direction with increasing the frequency due to mass effect, the dipole can be more easily rearranged in a low electric field than a spontaneous polarization. In FIG. 8, a principle of restraining an eddy current direction using this phenomenon is shown.

FIG. 8 is a conceptual view illustrating the principle of restraining the eddy current direction using a micro dipole.

In (a) of FIG. 8, an eddy current 70 generated as shown in FIG. 5 flows in a direction indicated by an arrow 75, and a dipole 73 generated between a micro polar region 71 and a matrix 72 is arranged in an electric-field direction 74.

At this time, when the direction of the electric field generated from the tag to create the eddy current 70 is rapidly changed at 900 MHz, the dipole is not rearranged in synchronization with the frequency as in the ionic dipole in (b) of FIG. 5. Hence, a dipole 73 created by the micro polar region maintains an initial polarization direction 73 and restrains an electric-field direction 74 so as to maintain the eddy current direction as indicated by an arrow 75 in (b) of FIG. 8 by restraining the eddy current directions 75 and 75 from being changed despite reduction in magnetic field from the tag.

Therefore, generation of the inverse magnetic field according to the right hand rule is suppressed. In this regard, it was proven that Comparative Example 1 failed to suppress generation of the eddy current since it was formed of a typical ferroelectric material where the micro polar region is not present, whereas Example 1 could prevent the generation of the eddy current since it was formed of the relaxor ferroelectric material having a certain thickness according to the present invention.

### Comparative Example

0.97(BaTiO₃)+0.99Y₂O₃+0.64MgO+0.09Cr₂O₃+0.05V₂O₅

BaTiO₃ prepared by a hydrothermal synthesis method was calcined at 1100° C. for 2 hours, and pulverized into a powder having a particle diameter of 0.4 mm.

Additives and a binder were sequentially added to BaTiO₃ powder, which in turn was subjected to wet-mixing for 24 hours with a ball mil, and then the mixture was dried.

The dried mixture was molded by using a press in a square shape, and then sintered to provide a square sintered compact having a size of 2.3 mm in thickness and 20×20 mm in length and width. Then, electrodes were attached to both sides of the sintered compact by baking, followed by measurement of a dielectric constant at 1 kHz and at room temperature by HP4194A. The dielectric constant of the sintered compact was 1,400.

FIG. 9 is a graph depicting variation in the dielectric constant depending on temperature in the Comparative Example.

In order to verify effects of an RF tag on a metal plate, a 912 MHz RFID Test Kit was prepared. Then, a tag antenna of the Test Kit was attached to the sintered specimen of the Comparative Example by a conductive silver epoxy, followed by curing at 150° C. for 1 hour.

Then, after attaching the tag to an aluminum piece, a test for transmission and reception between the RFID tag and a reader was performed. According to a test result, the tag was unable to perform transmission and reception functions.

According to the description of the aforementioned prior art, although λ/4 for minimizing RF reflection in air is 8.2 cm for an RF of 912 MHz, the use of a dielectric material having a dielectric constant of 1,400 can reduce the distance of λ/4 to 0.23 cm (2.3 mm).

However, according to the test result, it was found that the RF tag was not operated by an influence of the eddy current despite a dielectric constant of 1000 or more of the dielectric material used in this test. This can be interpreted as follows.

The prepared specimen is a typical ferroelectric material and has a spontaneous dipole and an ionic dipole disorderly arranged at room temperature. In the specimen, the total polarization amount of the disorderly arranged spontaneous dipole is 0. Further, since an electric field of at least 4 kV/mm is required to rearrange the spontaneous dipole in a predetermined direction at room temperature, the rearrangement of the spontaneous dipole cannot be obtained by the electric filed induced from RF.

Therefore, only the ionic dipole was affected by the electric field induced by the RF, and such an ionic polarization could be affected by an external electric field up to a frequency in the GHz range.

When the amount of the eddy current induced from the tag antenna was varied in the conductive silver epoxy deposited on the specimen, surface charges were also varied. Therefore, according to Lenz's rule, the variation of the eddy current generated from the silver epoxy causes generating an inverse magnetic field that could counterbalance the magnetic field from the reader antenna, so that a signal could not be transmitted between the tag and the reader antenna.

In other words, due to a circumstance as shown in FIG. 6, the inverse magnetic field may be emitted from the surface of the conductive silver epoxy. As a result, the specimen of this example could not attenuate the inverse magnetic field caused by the eddy current, so that the operation of the RFID was impossible.

### Embodiment 1

A composition of a specimen formed in one embodiment is (Ba_{0.82}Ca_{0.18})(Ti_{0.96-y}Zr_{y}Sn_{0.04})O₃ exhibiting characteristics of a typical relaxor ferroelectric substance, and was made by using BaTiO₃ (Batiotech, BT-01S) prepared by the hydrothermal method. In the specimen, a mole ratio of Ba/Ti measured by XRF was 0.995.

CaCO₃ (Ube, 99%), TiO₂ (Tronox, 99.9%), ZrO₂ (Daiich Kigenso Kagaku Kogyo Co., Ltd., EP grade) and SnO₂ (Kojundo, 99.9%) powders were used as additives, and a solid phase reaction process was applied.

As sintering additives, Bi₂O₃ (Kojundo, 99.9%) and SiO₂ (Kojundo, 99.9%) were used and MnCO₃ (Kojundo, 99.9%) was also used to reduce dielectric loss. In this regard, a constant amount of the sintering additives was added in the overall composition to eliminate influence of the sintering additives.

After weighing the powders to satisfy the composition, the powders were subjected to wet-mixing with ethanol for 16 hours by an yttria-stabilized zirconia ball. Then, the powder mixture was dried and calcined at 1100° C. for 2 hours, followed by wet-pulverization using the same ball as that of the wet-mixing.

To remove variation in sintering characteristics caused by the pulverization, the pulverization time was determined while measuring a particle distribution using a particle size analyzer (PSA) (Melvern Instrument Ltd., MICRO-P) such that D₉₀ was equal to 0.8.

The pulverized powder was dried and sieved through an 80-mesh standard sieve, followed by uniaxial pressing and then isostatic pressing at a pressure of 200 MPa in a metal mold of 24×24 mm in length and width, thereby providing a compact. The compact was sintered at a temperature elevation rate of 5° C./min in a temperature range of 1,320° C. for 2 hours.

The sintered compact was processed to have dimensions of 2.3 mm in thickness and 20×20 mm in length and width. In order to measure the dielectric constant of the sintered compact, specimens were prepared as follows.

First, after polishing opposite sides of the sintered compact using a double sided polisher to make the opposite sides coplanar, a Ga—In paste (Kojundo, 99.99%) was pasted on the surfaces of electrodes. The dielectric constant of each specimen and a loss thereof were measured at 1 kHz by an impedance gain phase analyzer (Hewlett Packard, Model HP4194A), and were automatically measured at temperature intervals of 0.2° C. using a domestically provided program while elevating the temperature in the range of −30˜90° C. in a temperature chamber (Delta Design, Model 9023).

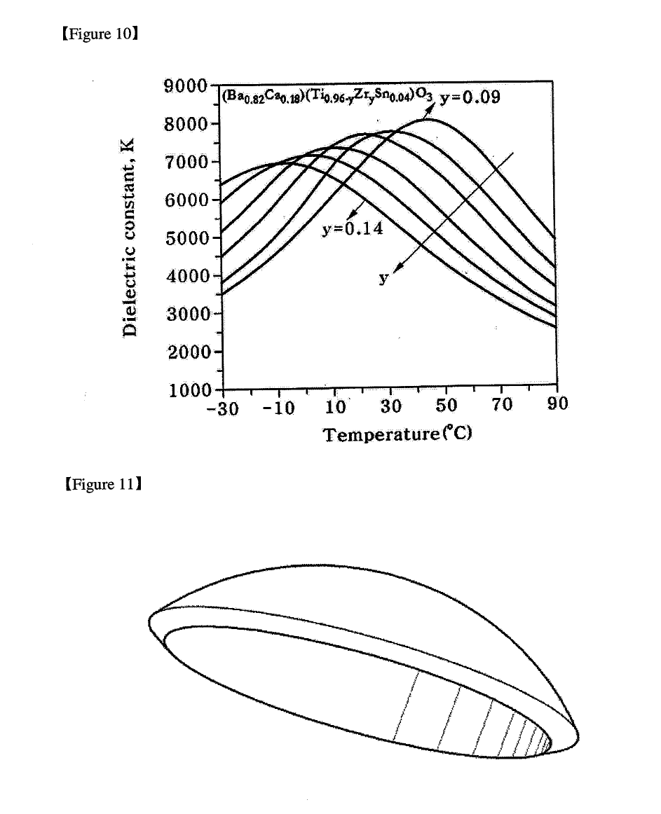

FIG. 10 is a graph depicting variation in dielectric constant depending on temperature when an added amount of ZrO₂ is increased from 9 mol % to 14 mol % in a composition of (Ba_{0.82}Ca_{0.18})(Ti_{0.96-y}Zr_{y}Sn_{0.04})O₃.

Each of the specimens was sintered for 2 hours at 1,320° C., at which a secondary phase is precipitated in a phase diagram. According to a test result, it can be understood that an increase in added amount of ZrO₂ results in a rapid decrease of Curie temperature and an increase of peak broadness caused by diffuse phase transition, unlike the result when adding CaO.

It is known that such a rapid decrease of Curie temperature is caused by induction of compression stress into an oxygen octagon unit lattice comprising Ti⁺⁴ near a Zr⁺⁴ site due to expansion of the unit lattice which includes Zr⁺⁴ by substitution of Ti⁺⁴ with Zr⁺⁴ having a greater ion radius at a Ti⁺⁴ site.

When Zr⁺⁴ having a large ion radius is located at the Ti⁺⁴ site by the substitution, an oxygen ion of the oxygen octagon comprising Zr⁺⁴ is forced in a <100> direction, so that a space in the <100> direction of Ti⁺⁴ located in an adjacent oxygen octagon is narrowed to suppress vibration of Ti⁺⁴, thereby increasing the diffuse phase transition.

In one embodiment, a composition of (Ba_{0.82}Ca_{0.18})(Ti_{0.85}Zr_{0.11}Sn_{0.04})O₃ was selected. Further, a tag antenna was attached to the specimen having a dielectric constant of 7,500 at room temperature, i.e. at 25° C., by the same method as in the Comparative Example, and the performance of the tag antenna was tested using the same test kit as that of the Comparative Example.

To verify that the inventive embodiment is differentiated from the Comparative Example, the test was performed by setting a thickness of the tag antenna to maximize the RF reflection. According to a test result, it was proven that it was possible to eliminate the attenuation phenomenon caused by the eddy current of RF by the effect of the micro region in the relaxor ferroelectric substance. For an RF of 912 MHz, λ/2 for minimizing the RF reflection in air is 16.4 cm (164 mm).

In other words, when the tag antenna is separated from a metal plate by this distance, the attenuation phenomenon caused by the eddy current is maximized, thereby causing inoperability of the RFID. According to the prior art, when using a dielectric material having a dielectric constant of 7,500, designing the dielectric substrate with a thickness of 1.89 mm maximizes the attenuation phenomenon caused by the eddy current, thereby causing the inoperability of the RFID.

However, for this example, normal operation of the RFID was confirmed. That is, in embodiment 1, a dipole created between the matrix and the micro polar region of the relaxor ferroelectric substance was dominantly operated instead of an ionic dipole, to restrain variation in direction of the eddy current as shown in FIG. 8, so that the inverse magnetic field generated by Lenz's rule is not generated, thereby enabling the RFID to operate normally on the surface of the metal plate.

Accordingly, this example eliminates the RF attenuation phenomenon caused by the eddy current, and permits manufacture of a tag capable of performing normal transmission and reception of signals on the surface of the metal. Further, in this example, the requirement that the thickness be λ/4 is eliminated, so that the thickness of the relaxor ferroelectric substance is not restricted.

### Embodiment 2

In consideration of transmission and reception of signals, a tag antenna for improving directivity was manufactured by attaching the tag antenna to a ferroelectric substrate, which was manufactured in a parabolic shape, as shown in FIG. 11, by powder injection molding.

When the tag antenna was disposed on a convex surface, a signal transmitted from the tag was widely expanded, thereby increasing a reception angle of the reader, and when the tag antenna was disposed on a concave surface, it was possible to increase the orientation.

Although the present invention has been described with reference to the embodiments and the accompanying drawings, the present invention is not limited to these embodiments. It should be understood by a person having ordinary knowledge in the art that various modifications, additions and substitutions can be made without departing from the scope and spirit of the invention. Thus, it should be noted that, in all aspects, the aforementioned embodiments are given by way of illustration and do not limit the present invention, as defined only the accompanying claims.

### INDUSTRIAL APPLICABILITY

The present invention can be applied to various RFD systems.

1. An RFID tag comprising:
an electronic chip configured to store information;
a tag antenna configured to transmit and receive an RF signal to and from a reader antenna; and
a substrate having the electronic chip and the tag antenna formed thereon,
wherein the substrate comprises a relaxor ferroelectric substance having a micro polar region formed therein.

2. The RFD tag according to claim 1, wherein the tag antenna is bonded to at least one side of the relaxor ferroelectric substrate having the micro polar region by a conductive epoxy.

3. The RFID tag according to claim 1, wherein the relaxor ferroelectric substrate having the micro polar region forms a dipole between the micro polar region and a matrix, and the dipole generates a dielectric constant attenuating phenomenon according to a frequency.

4. The RFID tag according to claim 3, wherein the dielectric constant attenuating phenomenon is generated when the dipole formed between the micro polar region and the matrix fails to convert a polarization direction corresponding to the frequency.

5. The RFID tag according to claim 2, wherein an electric field is generated from the tag antenna to induce an eddy current into the conductive epoxy by a magnetic field sent from the reader antenna to the tag antenna, the eddy current having an inverse direction to a direction of the electric filed generated from the tag antenna.

6. The RFID tag according to claim 3, wherein the dipole formed between the micro polar region and the matrix does not convert a polarization direction corresponding to a direction of the electric field at a frequency of several MHz or more.

7. The RFID tag according to claim 3, wherein the dielectric constant attenuating phenomenon is generated from about −40° C. to about 60° C.

8. The RFID tag according to claim 1, wherein the relaxor ferroelectric substance has a composition of ABO₃.
A: one selected from the group consisting of: Pb⁺², Ca⁺², Ba⁺², La⁺³, Na⁺¹, K⁺¹, Ce⁺³, Bi⁺³, and a mixture thereof
B: one selected from the group consisting of: Mg⁺², Nb⁺⁵, Ti⁺⁴, Zr⁺⁴, Ta⁺⁵, W⁺⁶, Mn⁺², Ni⁺², Co⁺², Y⁺³, Te⁺⁶, and a mixture thereof.

9. The RFID tag according to claim 8, wherein if A is a mixture of two ions, a mixing ratio of the two ions of A is 1/2:1/2, and if B is a mixture of two ions, a mixing ratio of the two ions of B is one of 1/2:1/2 or 1/3:2/3.

10. The RFID tag according to claim 1, wherein a temperature for forming the micro polar region to be present in the relaxor ferroelectric substance is adjusted to be equal to a temperature at which the RFID tag is used.

11. The RFID tag according to claim 1, wherein a temperature for forming the micro polar region to be present in the relaxor ferroelectric substance is in the range of from about −40° C. to about 60° C.

12. The RFID tag according to claim 1, wherein the substrate comprising the relaxor ferroelectric substance having the micro polar region has a composition of (Ba_{0.82}Ca_{0.18})(Ti_{0.96-y}Zr_{y}Sn_{0.04})O₃, and is formed by adding Bi₂O₃ and SiO₂ as sintering additives and adding MnCO₃ for reducing dielectric loss.

13. The RFID tag according to claim 12, wherein an amount of Zr is adjusted in the substrate comprising the relaxor ferroelectric substance having the micro polar region such that a temperature for forming the micro polar region to be present in the relaxor ferroelectric substance is equal to a temperature at which the RFID tag is used.

14. A method for manufacturing an RFID tag substrate having a composition of (Ba_{0.82}Ca_{0.18})(Ti_{0.96-y}Zr_{y}Sn_{0.04})O₃ and exhibiting characteristics of a relaxor ferroelectric substance, the method comprising:
preparing a mixture of BaTiO₃, CaCO₃, TiO₂, ZrO₂, and SnO₂ powders by wet-mixing for from about 15 hours to about 17 hours;
preparing a first powder by drying and calcining the mixture at 900˜1100° C. for from about 1 hour to about 3 hours;
preparing a second powder by wet-pulverizing the first powder for from about 15 to about 17 hours, followed by drying the pulverized first powder;
preparing a compact by pressing the second powder; and
sintering the compact at from about 1,300° C. to about 1,350° C. for from about 1 hour to about 3 hours at a temperature elevation rate of from about 3° C./min to about 7° C./min.

15. The method according to claim 14, further comprising:
weighing the mixture of the powders to satisfy the composition of (Ba_{0.82}Ca_{0.18})(Ti_{0.96-y}Zr_{y}Sn_{0.04})O₃ before preparing the mixture.

16. The RFID tag according to claim 14, wherein the wet-mixing and the wet-pulverizing are performed using ethanol.

17. The RFID tag according to claim 14, wherein the wet-mixing and the wet-pulverizing are performed using an yttria-stabilized zirconia ball.

18. The method according to claim 14, wherein the preparing a second powder is performed while measuring a particle distribution such that D₉₀ is equal to about 0.8, to remove variation in sintering characteristics caused by a pulverization effect.

19. The method according to claim 14, wherein the preparing a compact comprises sieving the second powder using a sieve of from about 70 mesh to about 90 mesh and pressing the sieved second powder.
